(19) United States
(12) Patent Application Publication
(10) Pub. No.: US 2025/0348017 A1
(43) Pub. Date: Nov. 13, 2025

(54) IMAGE FORMING APPARATUS, METHOD FOR CONTROLLING IMAGE FORMING APPARATUS, AND STORAGE MEDIUM STORING PROGRAM CODE FOR CONTROLLING IMAGE FORMING APPARATUS

(71) Applicant: Koichi KAWASAKI, Kanagawa (JP)

(72) Inventor: Koichi KAWASAKI, Kanagawa (JP)

(73) Assignee: Ricoh Company, Ltd., Tokyo (JP)

(21) Appl. No.: 19/172,173

(22) Filed: Apr. 7, 2025

(30) Foreign Application Priority Data
May 8, 2024 (JP) 2024-075826

(51) Int. Cl. G03G 15/02

(52) U.S. Cl. CPC G03G 15/0266; G03G 15/0283

(57) ABSTRACT

An image forming apparatus includes an image bearer, a charger, a voltage generator, a current detector, a sensor, a first storage, a second storage, and circuitry. The current detector detects a current flowing between the voltage generator and the image bearer. The sensor measures temperature and humidity. The first storage and the second storage store a reference alternating current (AC) voltage value and a used AC voltage value, respectively. The circuitry controls the voltage generator to generate an AC voltage based on the used AC voltage value detected when the circuitry detects that the used AC voltage value is stored in a section of a measured operating environment, and controls the voltage generator to generate an AC voltage based on the reference AC voltage value stored in the section of the measured operating environment when the used AC voltage value is absent in the section of the measured operating environment.

### CROSS-REFERENCE TO RELATED APPLICATION

This patent application is based on and claims priority pursuant to 35 U.S.C. § 119 (a) to Japanese Patent Application No. 2024-075826, filed on May 8, 2024, in the Japan Patent Office, the entire disclosure of which is hereby incorporated by reference herein.

### BACKGROUND

### Technical Field

The present disclosure relates to an image forming apparatus, a method for controlling the image forming apparatus, and a storage medium storing program code for controlling the image forming apparatus.

### Related Art

For example, a method has been proposed that determines a peak value of a charging voltage such that the alternating current (AC) current flowing at the time of applying the charging voltage becomes a target value with reference to the previous charging voltage in a charging process of applying an AC charging voltage to a photoconductor drum of an image forming apparatus. Further, a method also has been proposed that refers to a past history held in a memory and uses a peak value of a charging voltage in a similar environment when the charging voltage obtained by rotating a photoconductor drum at the time of starting an image forming apparatus continuously indicates an abnormal value a specified number of times.

### SUMMARY

The present disclosure described herein provides an image forming apparatus that includes an image bearer, a charger, a voltage generator, a current detector, a sensor, a first storage, a second storage, and circuitry. An electrostatic latent image is formed on the image bearer. The charger charges the image bearer based on an alternating current (AC) voltage. The voltage generator generates the AC voltage to be supplied to the charger. The current detector detects a current flowing between the voltage generator and the image bearer. The sensor measures temperature and humidity, as an operating environment, inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. The circuitry controls the voltage generator to generate an AC voltage based on the used AC voltage value detected when the circuitry detects that the used AC voltage value is stored in a section of a measured operating environment, which is an operating environment measured by the sensor, in the second storage, and controls the voltage generator to generate an AC voltage based on the reference AC voltage value stored in the section of the measured operating environment in the first storage when the used AC voltage value is absent in the section of the measured operating environment in the second storage.

The present disclosure described herein also provides an image forming apparatus that includes an image bearer, a charger, a voltage generator, a current detector, a sensor, a first storage, a second storage, and circuitry. An electrostatic latent image is formed on the image bearer. The charger charges the image bearer based on an AC voltage. The voltage generator generates the AC voltage to be supplied to the charger. The current detector detects a current flowing between the voltage generator and the image bearer. The sensor measures temperature and humidity, as an operating environment, inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. The circuitry controls the voltage generator to generate an AC voltage based on the used AC voltage value when the used AC voltage value stored in a section of a measured operating environment, which is an operating environment measured by the sensor, in the second storage is smaller than an upper limit AC voltage value obtained by adding a margin to the reference AC voltage value stored in the section of the measured operating environment in the first storage, and controls the voltage generator to generate an AC voltage based on the reference AC voltage value when the used AC voltage value is the upper limit AC voltage value or more.

The present disclosure described herein further provides a method for controlling an image forming apparatus that includes an image bearer, a charger, a voltage generator, a current detector, a sensor, a first storage, a second storage, and circuitry. An electrostatic latent image is formed on the image bearer. The charger charges the image bearer based on an

AC voltage. The voltage generator generates the AC voltage to be supplied to the charger. The current detector detects a current flowing between the voltage generator and the image bearer. The sensor measures temperature and humidity, as an operating environment, inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. The method includes controlling, by the circuitry, the voltage generator to generate an AC voltage based on the used AC voltage value detected when the circuitry detects that the used AC voltage value is stored in a section of a measured operating environment, which is an operating environment measured by the sensor, in the second storage, and controlling, by the circuitry, the voltage generator to generate an AC voltage based on the reference AC voltage value stored in the section of the measured operating environment of the first storage when the used AC voltage value is absent in the section of the measured operating environment in the second storage.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating an overall configuration of an image forming apparatus according to a first embodiment of the present disclosure;

FIG. 2 is a schematic diagram illustrating an example of a part that performs an electrophotographic process in the image forming apparatus of FIG. 1;

FIG. 3 is a functional block diagram illustrating a configuration of a controller and a high-voltage power supply of FIG. 1;

FIG. 4 is a diagram illustrating an example of a reference AC voltage value and a used AC voltage value stored in a memory of FIG. 3;

FIG. 5 is a flowchart of control of a charging current by the controller of FIG. 3;

FIG. 6 is a diagram illustrating an example of various data stored in a memory of an image forming apparatus according to a second embodiment of the present disclosure;

FIG. 7 is a diagram illustrating an example of various data stored in a memory of an image forming apparatus according to a third embodiment of the present disclosure;

FIG. 8 is a flowchart of control of a charging current by a controller of the third embodiment; and

FIG. 9 is a block diagram illustrating a hardware configuration of a controller according to the first to third embodiments.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In each drawing, identical or like reference signs are assigned to identical or like elements or components and descriptions of those elements or components may be simplified or omitted. As used herein, the singular forms “a,” “an,” and “the” are intended to include the plural forms as well, unless the context clearly indicates otherwise.

### First Embodiment

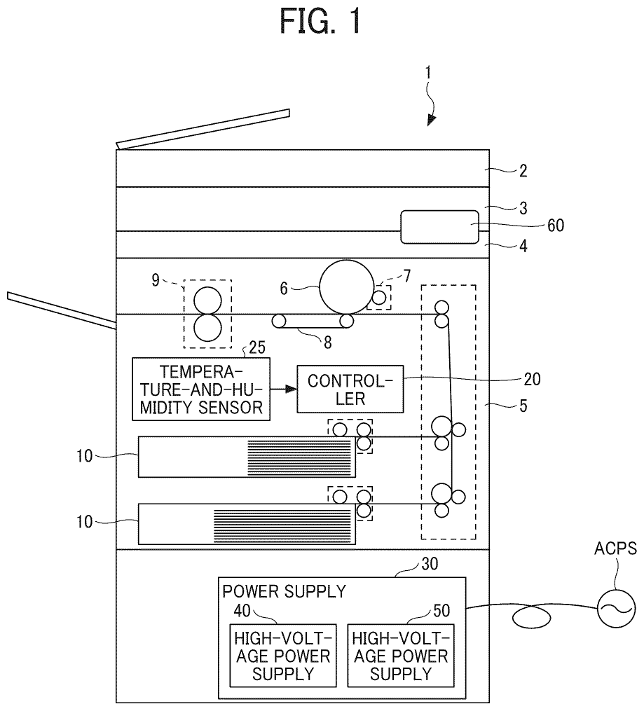

FIG. 1 is a diagram illustrating an overall configuration of an image forming apparatus according to a first embodiment of the present disclosure. An image forming apparatus 1 illustrated in FIG. 1 is a digital multi-function peripheral (MFP) having, for example, a copying function, a printing function, a scanner function, and a facsimile function. The image forming apparatus 1 can sequentially switch operation modes that implement a copier function, a printer function, a scanner function, and a facsimile function with an application switch key of the operation unit of the image forming apparatus 1. In response to the selection of the copier function, the image forming apparatus 1 operates in a copy mode. In response to the selection of the printing function, the image forming apparatus 1 operates in printer mode. In response to the selection of the document scanner function, the image forming apparatus 1 operates in a scanner mode. In response to the selection of the facsimile function, the image forming apparatus 1 operates in a facsimile mode.

The image forming apparatus 1 switches internal states to an operating mode (a state in which the image forming apparatus 1 is being operated), a standby mode (a state in which the image forming apparatus 1 is standby), and an energy saving mode, in accordance with the state of an internal circuit. The energy saving mode is also referred to as a power saving mode below.

For example, the operating mode includes the copy mode or a printer mode in which an image or text data is printed on, for example, a paper medium. The printer mode includes an operation of printing received data on, for example, a paper medium in the facsimile mode. The operating mode includes transmission and reception operations in a scanner mode in which, for example, a document is scanned or a facsimile mode. The state of the internal circuit is switched by the operation of the operation unit by a user or the control in the image forming apparatus 1.

For example, the image forming apparatus 1 may include an automatic document feeder (ADF) 2, an image reading device 3, a writing unit 4, a printer unit 5, a controller 20, a temperature-and-humidity sensor 25, a power supply 30, and an operation unit 60. The printer unit 5 includes a photoconductor drum 6, a developing device 7, a conveying belt 8 (an intermediate transfer belt), a fixing device 9, and a storage space in which a sheet feed tray 10 is stored. The power supply 30 includes a high-voltage power supply 40 and a high-voltage power supply 50. The printer unit 5 is an example of a body of the image forming apparatus 1.

A brief description is given below of a procedure of image formation in the image forming apparatus 1, which is a case where the operation mode is set to the copy mode.

In the copy mode, a plurality of documents to be copied are set on the automatic document feeder 2, or a document to be copied is set on the image reading device 3. When a start button displayed on the operation unit 60 is pressed, the automatic document feeder 2 feeds documents one by one to the image reading device 3. The image reading device 3 reads image data of each of the documents sequentially fed from the automatic document feeder 2 or the document set on the image reading device 3. The image information read by the image reading device 3 is processed by, for example, an image processor mounted on the controller 20.

The writing unit 4 converts the image data processed by the image processor into optical data. The printer unit 5 exposes the charged surface of the photoconductor drum 6 based on image information to form an electrostatic latent image, and develops the electrostatic latent image with the developing device 7 to form a toner image. The printer unit 5 transfers the toner image onto a paper medium via the conveying belt 8 (the intermediate transfer belt), and fixes the toner image transferred onto the paper medium by the fixing device 9. The paper medium on which the toner image of the document is copied is ejected from an ejection section.

For example, the standby mode described above is a state until the start button is pressed in the copy mode. The operating mode is a state until a paper medium is ejected after the start button is pressed. After the operating mode is finished, the state of the image forming apparatus 1 returns to the standby mode. When the standby mode continues for a specified time, the image forming apparatus 1 enters the energy saving mode. When the operation unit 60 is operated during the energy saving mode, the image forming apparatus 1 returns to the standby mode.

The operation unit 60 receives various inputs according to user operations in an input unit and displays various information on a display of the operation unit 60. For example, the information displayed on the display of the operation unit 60 includes information indicating an operation for which input is accepted, information indicating an operation status of the image forming apparatus 1, and information indicating a setting state of the image forming apparatus 1.

The controller 20 causes a controller such as a built-in central processing unit (CPU) to execute a control program. As a result, the controller 20 controls the overall operation of the image forming apparatus 1, such as control of the printer unit 5, control of the power supply 30, control of communication, and control of input to the operation unit 60. For example, the control program may include an operation control program that controls the printer unit 5, an image processing program that performs image processing on an image formed by the printer unit 5, and a power supply control program that controls the power supply 30. The controller 20 executes the control program to perform a process of transferring an image obtained by image processing to, for example, a paper medium.

The temperature-and-humidity sensor 25 is disposed, for example, in the printer unit 5, measures the temperature and humidity in the printer unit 5, and outputs temperature information indicating the measured temperature and humidity information indicating the measured humidity to the controller 20. The temperature-and-humidity sensor 25 is an example of a measurement unit that measures temperature and humidity in the printer unit 5, and the temperature and humidity are examples of an operating environment in the printer unit 5. The controller 20 adjusts a target value (for example, a peak value) of the alternating current flowing between the high-voltage power supply 40 and the photoconductor drum 6 based on the temperature information and the humidity information from the temperature-and-humidity sensor 25, and controls the high-voltage power supply 40 so that the alternating current value approaches the target value.

The power supply 30 includes the high-voltage power supply 40 that generates an AC voltage based on an AC voltage supplied from an AC power supply ACPS such as a commercial power supply, and the high-voltage power supply 50 that generates a direct current (DC) voltage. The power supply 30 supplies the generated AC voltage and DC voltage to various loads such as the printer unit 5. Examples of the loads include various motors, a charging device that charges the photoconductor drum 6, a developing roller of the developing device 7, and the controller 20 including a CPU and a memory.

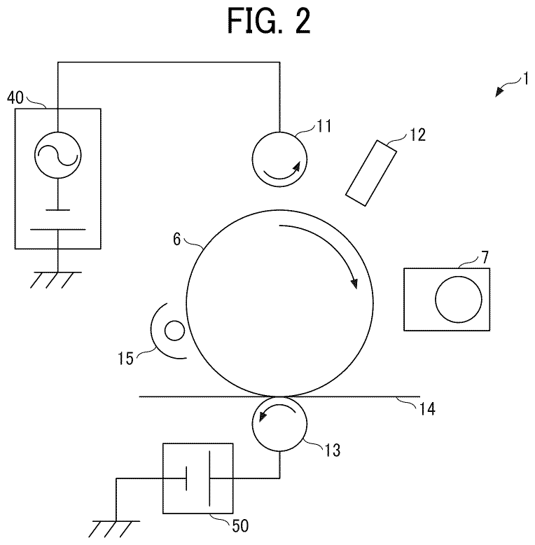

FIG. 2 is a diagram illustrating an example of a part that performs an electrophotographic process in the image forming apparatus 1 of FIG. 1. A detailed description may be omitted of the same or like operations as the operations described with reference to FIG. 1.

The image forming apparatus 1 includes the photoconductor drum 6, a charging roller 11, an exposure unit 12, the developing device 7, a transfer roller 13, an intermediate transfer belt 14, a static eliminator 15, the high-voltage power supply 40, and the high-voltage power supply 50. The image forming apparatus 1 forms an image by an electrophotographic method. The photoconductor drum 6 is an example of an image bearer on which an electrostatic latent image is formed. The charging roller 11 is an example of a charger.

The high-voltage power supply 40 generates a high voltage (for example, a negative voltage) by superimposing a high-voltage DC voltage and a high-voltage AC voltage, and applies the generated high voltage to the charging roller 11. The high-voltage power supply 50 generates a DC high voltage (for example, a positive voltage) and applies the generated high voltage to the transfer roller 13.

The charging roller 11 contacts the photoconductor drum 6 or is in close proximity to the photoconductor drum 6 with a distance of approximately several tens of microns, and generates discharge between the surface of the photoconductor drum 6 and the surface of the charging roller 11 by a high voltage applied from the high-voltage power supply 40. Thus, the surface of the photoconductor drum 6 is uniformly charged to a specified potential. In the example illustrated in FIG. 2, the photoconductor drum 6 rotates clockwise, and the charging roller 11 and the transfer roller 13 rotate counterclockwise.

The exposure unit 12, which converts the image information processed by the image processor into optical information, exposes the surface of the photoconductor drum 6 in response to the image signal, thereby forming an electrostatic latent image on the photoconductor drum 6. The developing device 7 develops the electrostatic latent image formed on the photoconductor drum 6 to form a toner image on the photoconductor drum 6. The transfer roller 13 transfers the toner image on the photoconductor drum 6 onto the intermediate transfer belt 14 by a high voltage applied from the high-voltage power supply 50.

The toner image transferred to the intermediate transfer belt 14 is transferred to, for example, a paper medium by a transfer unit, and then fixed by the fixing device 9 illustrated in FIG. 1. As a result, an image is formed on, for example, a paper medium. In the case of the direct transfer method, for example, a paper medium is disposed instead of the intermediate transfer belt 14. Thus, a toner image on the photoconductor drum 6 is directly transferred onto, for example, the paper medium. In the following description, forming an image by the image forming apparatus 1 is also referred to as printing.

The static eliminator 15 eliminates the charge on the surface of the photoconductor drum 6 after the toner image on the photoconductor drum 6 is transferred onto the intermediate transfer belt 14. The image forming apparatus 1 may not include the static eliminator 15.

When the image forming apparatus 1 forms a color image, the printer unit 5 (see FIG. 1) includes elements positioned opposite the transfer roller 13 with respect to the intermediate transfer belt 14 in FIG. 2 for each of colors of yellow, magenta, cyan, and black. The image forming apparatus 1 sequentially transfers the toner images of the respective colors to the intermediate transfer belt 14 provided in common for the four colors in a superimposed manner. Thereafter, the toner image formed in full color on the intermediate transfer belt 14 is transferred onto, for example, a paper medium by a transfer section, and then fixed by the fixing device 9. The present embodiment is applied to the image forming apparatus 1 that forms a color image.

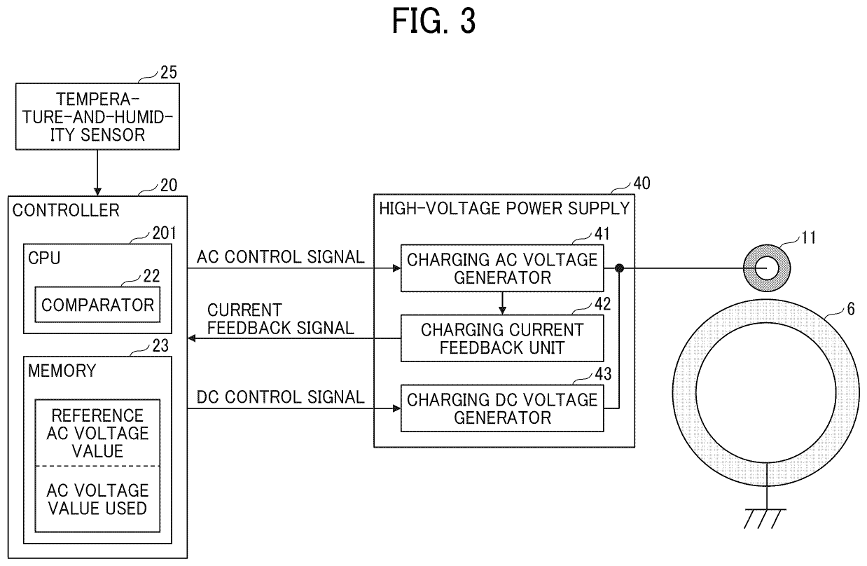

FIG. 3 is a functional block diagram illustrating a configuration of the controller 20 and the high-voltage power supply 40 of FIG. 1. FIG. 3 typically illustrates elements used for controlling charging of the charging roller 11.

The controller 20 includes a CPU 201 and a memory 23. The memory 23 may be disposed outside the controller 20. The high-voltage power supply 40 includes a charging AC voltage generator 41, a charging current feedback unit 42, and a charging DC voltage generator 43. The high-voltage power supply 40 is an example of a voltage generator that generates an AC voltage by superimposing an AC voltage on a DC voltage.

For example, the CPU 201 implements the function of a comparator 22 by executing the control program. For example, as to be described later, the comparator 22 compares a detection feedback (FB) value corresponding to the charging AC current with a target FB value which is a voltage value corresponding to a target value of the charging AC current. The controller 20 may include devices such as an application-specific integrated circuit (ASIC) or a field-programmable gate array (FPGA) instead of the CPU 201.

For example, the memory 23 includes an area that stores a reference AC voltage value and a used AC voltage value used for causing the high-voltage power supply 40 to generate an AC voltage. The reference AC voltage value is stored in the memory 23 when the image forming apparatus 1 is manufactured or when firmware is updated. For example, the reference AC voltage value indicates a reference AC voltage value at which a protection function for a circuit by an overcurrent protection device disposed in the image forming apparatus 1 does not operate, and is calculated in advance by an experiment.

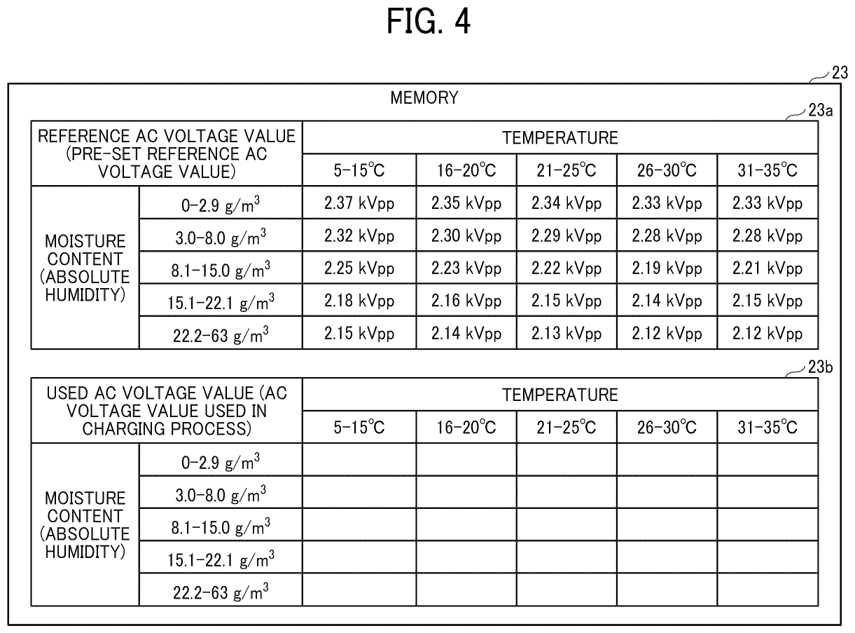

A used AC voltage value indicates an AC voltage value used for application to a charging roller in the charging process during printing by the image forming apparatus 1. The used AC voltage value is not stored in the memory 23 at the time of manufacturing the image forming apparatus 1, but is stored in the memory 23 after the charging process is performed. Examples of the reference AC voltage value and the used AC voltage value stored in the memory 23 are illustrated in FIG. 4.

The memory 23 may store, for example, the charging bias value (the DC voltage value, the peak-to-peak voltage value of the AC voltage, and the frequency of the AC voltage) generated by the high-voltage power supply 40 and various parameters used for the operation of the image forming apparatus 1. For example, the memory 23 is a nonvolatile memory such as an electrically rewritable flash memory.

The controller 20 outputs an AC control signal that causes the charging AC voltage generator 41 to generate an AC voltage and a DC control signal that causes the charging DC voltage generator 43 to generate a DC voltage to the high-voltage power supply 40, and receives a current feedback signal from the high-voltage power supply 40.

The charging AC voltage generator 41 generates an AC voltage in response to an AC control signal from the controller 20, and outputs the generated AC voltage to the charging roller 11. For example, the AC control signal may be a pulse width modulation (PWM) signal. The charging DC voltage generator 43 generates a DC voltage in response to a DC control signal from the controller 20, and outputs the generated DC voltage to the charging roller 11. The charging roller 11 is supplied with an AC voltage obtained by superimposing the AC voltage generated by the charging AC voltage generator 41 and the DC voltage generated by the charging DC voltage generator 43.

The charging current feedback unit 42 detects the value of a charging current flowing from the photoconductor drum 6 to the high-voltage power supply 40 via the charging roller 11 during the period in which a voltage is supplied from the high-voltage power supply 40 to the charging roller 11. For example, the charging current feedback unit 42 may acquire, from the charging AC voltage generator 41, the voltage values at both ends of a micro fixed resistor inserted into a power supply line that applies the AC voltage from the charging AC voltage generator 41 to the charging roller 11, and detect the charging current value based on the voltage difference between both ends of the micro fixed resistor. The charging current feedback unit 42 is an example of a current detector that detects a current flowing from the high-voltage power supply 40 to the photoconductor drum 6.

The charging current feedback unit 42 outputs a current feedback signal indicating the detected charging current value to the controller 20. For example, the charging current feedback unit 42 may output information indicating the voltage difference between both ends of the micro fixed resistor to the controller 20 as a current feedback signal. In the following description, the voltage corresponding to the charging current indicated by the current feedback signal is also referred to as a detection FB value.

The charging current flows when the photoconductor drum 6 is charged (discharged) via the charging roller 11. For example, the charging current feedback unit 42 may detect the charging current value a plurality of times at a specified cycle during one rotation of the photoconductor drum 6.

The controller 20 compares the detection FB value indicated by the current feedback signal output from the charging current feedback unit 42 with the target FB value which is a voltage value corresponding to the target value of the charging current. The controller 20 generates an AC control signal that makes the detection FB value approach the target FB value, and outputs the AC control signal to the charging AC voltage generator 41. The detection FB value and the target FB value may be compared by the comparator 22. The controller 20 generates a DC control signal that causes the charging DC voltage generator 43 to generate a DC voltage that is an offset voltage of the voltage to be output to the charging roller 11, and outputs the generated DC control signal to the charging DC voltage generator 43.

The controller 20, for example, outputs the AC voltage and the DC voltage from the high-voltage power supply 40, and reads the reference AC voltage value or the used AC voltage value stored in the memory 23 as the initial AC voltage value of the charging process at a specified timing when the controller 20 rotates the photoconductor drum 6. The controller 20 reads the reference AC voltage value or the used AC voltage value stored in the memory 23 in correspondence with the section of the operating environment indicated by the temperature and the humidity measured by the temperature-and-humidity sensor 25.

FIG. 4 is a diagram illustrating an example of the reference AC voltage value and the used AC voltage value stored in the memory 23 of FIG. 3. The reference AC voltage value, which is a preset AC voltage value, is stored in a storage area 23a allocated in the memory 23. The used AC voltage value, which is the AC current value used in the charging process, is stored in a storage area 23b allocated in the memory 23.

The storage area 23a has twenty-five sections of the operating environment, which are obtained from five ranges of temperature and five ranges of moisture content (absolute humidity), and holds the reference AC voltage value in each section. Similarly, the storage area 23b has twenty-five sections of the operating environment, which are obtained from five ranges of temperature and five ranges of moisture content (absolute humidity) as the storage area 23a, and holds the used AC voltage value in each section. The moisture content (absolute humidity) can be calculated from the temperature and the relative humidity measured by the temperature-and-humidity sensor 25. The humidity described below indicates absolute humidity.

The states of the storage areas 23a and 23b illustrated in FIG. 4 indicate, for example, an initial state immediately after the image forming apparatus 1 is manufactured (that is, before shipment). When the printing operation is not performed, the AC current value used in the charging process does not present, and thus the AC voltage value is not stored in the storage area 23b. In the storage area 23b, the AC voltage value used in the charging process is stored as the used AC voltage value in the section indicating the operating environment at the time of performing the printing operation in each time the charging process is performed in the printing operation after shipment of the image forming apparatus 1.

The storage area 23a is an example of a first storage in which the reference AC voltage value is stored, and the storage area 23b is an example of a second storage in which the used AC voltage value is stored. The number of sections of the operating environment stored in the storage areas 23a and 23b is not limited to 25.

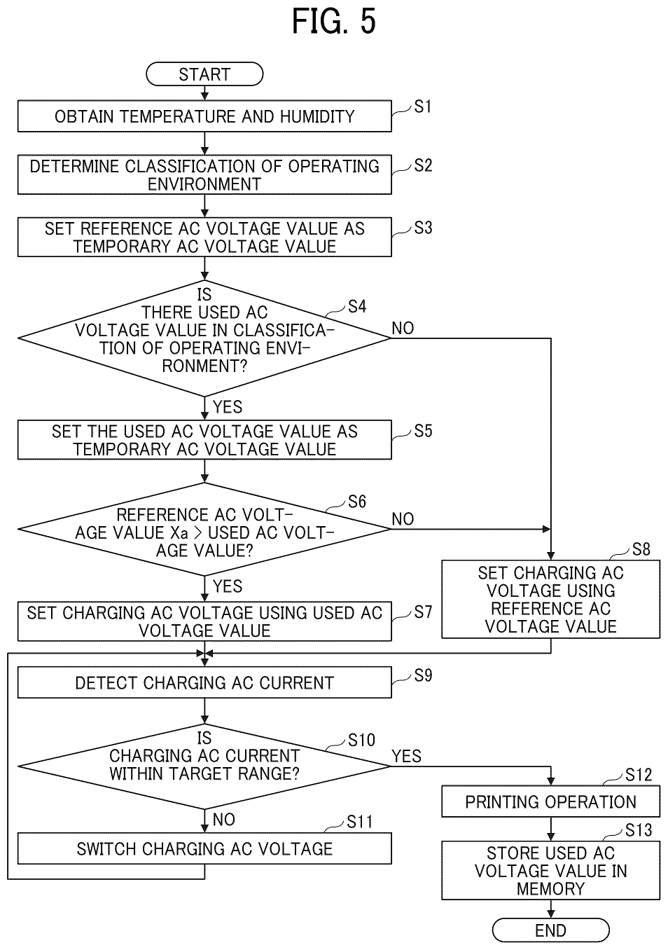

FIG. 5 is a flowchart of an example of the control of the charging current by the controller 20 of FIG. 3. FIG. 5 illustrates an example of a control method of the image forming apparatus 1 or an example of a control program of the image forming apparatus 1. In other words, the operation illustrated in FIG. 5 may be implemented by a control program executed by the CPU 201 mounted on the controller 20. The controller 20 performs the operation procedure of FIG. 5 to control the charging AC voltage generator 41 and the charging DC voltage generator 43 of FIG. 3 to generate a specified voltage in which an AC voltage and a DC voltage are superimposed, and applies the generated voltage to the charging roller 11.

The operation illustrated in FIG. 5 is started at a specified timing, for example, when the image forming apparatus 1 is powered on, before the photoconductor drum 6 is charged to form an electrostatic latent image, or when a change in the environmental section such as temperature and humidity is detected. Although the control of the generation of the DC voltage of the high-voltage power supply 50 by the controller 20 is omitted in FIG. 5, the controller 20 causes the high-voltage power supply 50 to generate the DC voltage (positive voltage) when the controller 20 causes the high-voltage power supply 40 to generate the AC voltage (negative voltage).

First, in step S1, the controller 20 acquires temperature and relative humidity from the temperature-and-humidity sensor 25. In step S2, the controller 20 determines the section of the operating environment corresponding to the temperature and the relative humidity acquired in step S1. The operating environment corresponding to the current temperature and humidity measured by the temperature-and-humidity sensor 25 is an example of a measured operating environment.

In step S3, the controller 20 refers to the storage area 23a of the memory 23, and determines the reference AC voltage value stored in the area corresponding to the section of the operating environment determined in step S2 as a temporary AC voltage value to be used for the charging process. In step S4, the controller 20 determines whether the used AC voltage value is present in the area corresponding to the section of the operating environment determined in step S2 in the storage area 23b, performs step S5 when the controller 20 detects that the used AC voltage value is present, and performs step S8 when the controller 20 detects that the used AC voltage value is not present.

In step S5, the controller 20 determines the used AC voltage value detected in step S4 as the temporary AC voltage value used for a charging process. In step S6, the controller 20 determines whether the used AC voltage value determined in step S5 satisfies Equation (1).

Reference AC voltage value×a>used AC voltage value: Equation (1)

When the used AC voltage value is smaller than the value obtained by multiplying the reference AC voltage value by the coefficient a, the controller 20 determines that the overcurrent protection function is unlikely to operate due to the occurrence of the overcurrent in the charging process, and performs step S7. When the used AC voltage value is equal to or greater than the value obtained by multiplying the reference AC voltage value by the coefficient a, the controller 20 determines that the overcurrent protection function is likely to operate due to the occurrence of the overcurrent in the charging process, and performs step S8. For example, the coefficient a is a margin added to the reference AC voltage value, and is set to about 1.05 to 1.3. The value obtained by multiplying the reference AC voltage value by the coefficient a is an example of the upper limit AC voltage value.

In step S7, the controller 20 generates an AC control signal to be output to the charging AC voltage generator 41 using the used AC voltage value, and sets the charging AC voltage to be applied to the charging roller 11. On the other hand, in step S8, the controller 20 generates an AC control signal to be output to the charging AC voltage generator 41 using the reference AC voltage value, and sets the charging AC voltage to be applied to the charging roller 11.

After step S7 or step S8, in step S9, the controller 20 detects the charging AC current based on the current feedback signal from the charging current feedback unit 42 of FIG. 3. For example, the controller 20 samples the current feedback signal a plurality of times at a specified cycle while the photoconductor drum 6 rotates once, and calculates the average of the plurality of sampled current feedback signals as the charging AC current.

In step S10, the comparator 22 of the controller 20 compares the detection FB value corresponding to the charging AC current with the target FB value that is a voltage value corresponding to the target value of the charging AC current, and determines whether the charging AC current is within the target range.

When the charging AC current is within the target range, the controller 20 determines that the appropriate AC voltage is output from the charging AC voltage generator 41, and performs step S12. When the charging AC current is not within the target range, the controller 20 determines that the appropriate AC voltage is not output from the charging AC voltage generator 41, and performs step S11. In step S11, the controller 20 switches the charging AC voltage to perform control that makes the charging AC current approach the target value, and returns the process to step S9.

In step S12, the controller 20 performs a printing operation, and performs a process of forming an electrostatic latent image on the photoconductor drum 6, a process of developing the electrostatic latent image, a process of transferring a toner image formed on the photoconductor drum 6 by developing, for example, to a paper medium, and a process of fixing the toner image to the paper medium. In step S13, the controller 20 stores the AC voltage value actually used in the charging process of the printing operation as the used AC voltage value in the area corresponding to the section of the operating environment determined in step S2 in the storage area 23b of the memory 23, and ends the operation illustrated in FIG. 5.

As described above, in the first embodiment, the controller 20 performs the control of the charging process using the reference AC voltage value stored in the section of the operating environment at the time of performing the charging process in the storage area 23a. Such a configuration can make the charging AC current approach the target value quickly and shorten the initial setting time of the AC voltage applied to the photoconductor drum 6 as compared with the case where the charging process is controlled by using one reference AC voltage value regardless of the operating environment. In other words, the number of loops of steps S9 to S11 in FIG. 5 can be reduced.

The controller 20 stores the AC voltage value actually used in the charging process in the storage area 23b for each section of the operating environment. When the AC voltage value is stored in the area of the section of the operating environment at the time of performing the charging process in the storage area 23b, the controller 20 performs the control of the charging process using the AC voltage value. The AC voltage value used in the past is used in accordance with the section of the operating environment, so that the charging AC current can be brought closer to the target value more quickly, and the initial setting time of the AC voltage applied to the photoconductor drum 6 can be shortened.

The controller 20 stores the AC voltage value actually used in the charging process of the printing operation in the storage area 23b for each section of the operating environment. Such a configuration can sequentially update the AC voltage value for each section of the operating environment stored in the storage area 23b according to the individual difference of the image forming apparatus 1. For example, even when the characteristics of the components of the image forming apparatus 1 change over time, the controller 20 can cause the high-voltage power supply 40 to generate an appropriate AC voltage corresponding to the change over time. The appropriate AC voltage value corresponding to the individual difference of the image forming apparatus 1 can be held in the memory 23 for each section of the operating environment, so that the initial setting time of the AC voltage applied to the photoconductor drum 6 can be further shortened in accordance with the individual difference of the image forming apparatus 1.

When the AC voltage value stored in the storage area 23b is smaller than an upper limit AC voltage value obtained by adding a specified margin to the reference AC voltage value stored in the area of the same section of the operating environment in the storage area 23a, the controller 20 performs control of the charging process using the AC voltage value stored in the storage area 23b. With such a configuration, when the AC voltage value stored in the storage area 23b is used, the possibility that an overcurrent occurs in the charging process and the overcurrent protection function operates can be reduced.

### Second Embodiment

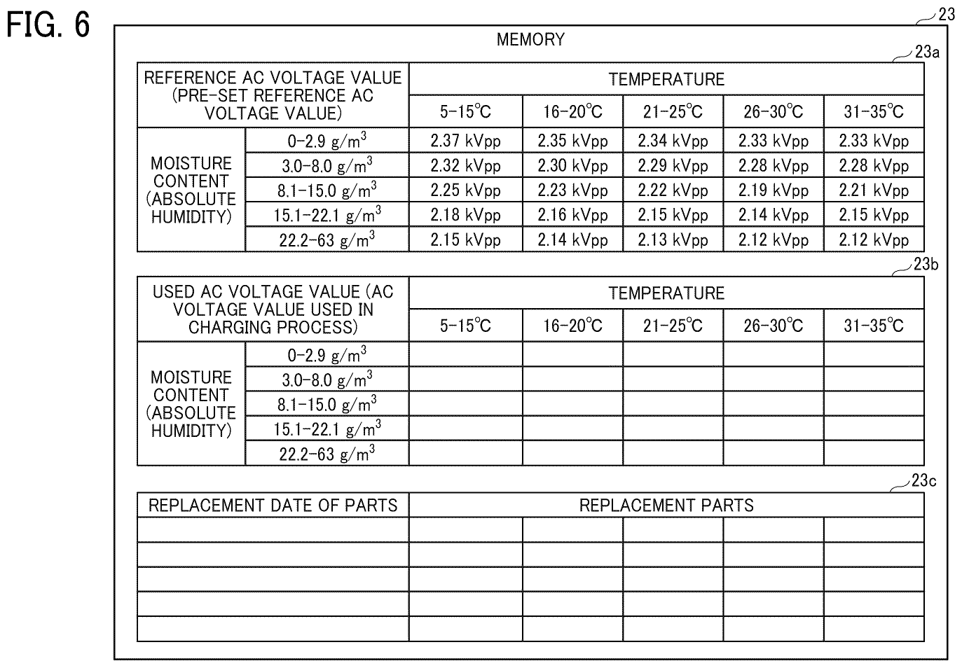

FIG. 6 is a diagram illustrating an example of various data stored in a memory 23 of an image forming apparatus 1 according to a second embodiment of the present disclosure. The memory 23 is substantially the same as the memory 23 illustrated in FIG. 4 except that the memory 23 has a storage area 23c that stores the replacement history of the components in the printer unit 5 in addition to the storage areas 23a and 23b illustrated in FIG. 4. For example, the storage area 23c includes an area that stores the replacement date of the components and a plurality of areas that store, for example, the name or the model of the replacement components. The storage area 23c is an example of a third storage. The configuration of the image forming apparatus 1 according to the second embodiment is substantially the same as the configuration of the image forming apparatus 1 illustrated in FIGS. 1 and 2.

The control of the charging current by the controller 20 in FIG. 1 is substantially the same as that in FIG. 5. However, when components related to the charging process among the components in the printer unit 5 are replaced and the replacement history is registered in the storage area 23c, the controller 20 initializes the storage area 23b by erasing the AC voltage value used in the charging process stored in the storage area 23b. The components related to the charging process are, for example, the charging roller 11, the photoconductor drum 6, the transfer roller 13, the intermediate transfer belt 14, and the static eliminator 15.

Initialization of the storage area 23b at the time of replacement of the components can prevent the AC voltage value used in the charging process before replacement of the components from exerting an influence on the AC voltage value to be used in the charging process after replacement of the components. As a result, the controller 20 can generate the AC control signal to be output to the charging AC voltage generator 41 by using the reference AC voltage value without being influenced by the properties of the components before replacement.

As described above, in the second embodiment, the initial setting time of the AC voltage applied to the photoconductor drum 6 can be shortened as in the first embodiment. In the second embodiment, the controller 20 initializes the storage area 23b at the time of replacement of components, which can prevent the AC voltage value used in the charging process before replacement of the components from exerting an influence on the AC voltage value used in the charging process after replacement of the component. Thus, the AC control signal to be output to the charging AC voltage generator 41 can be generated by using the reference AC voltage value.

### Third Embodiment

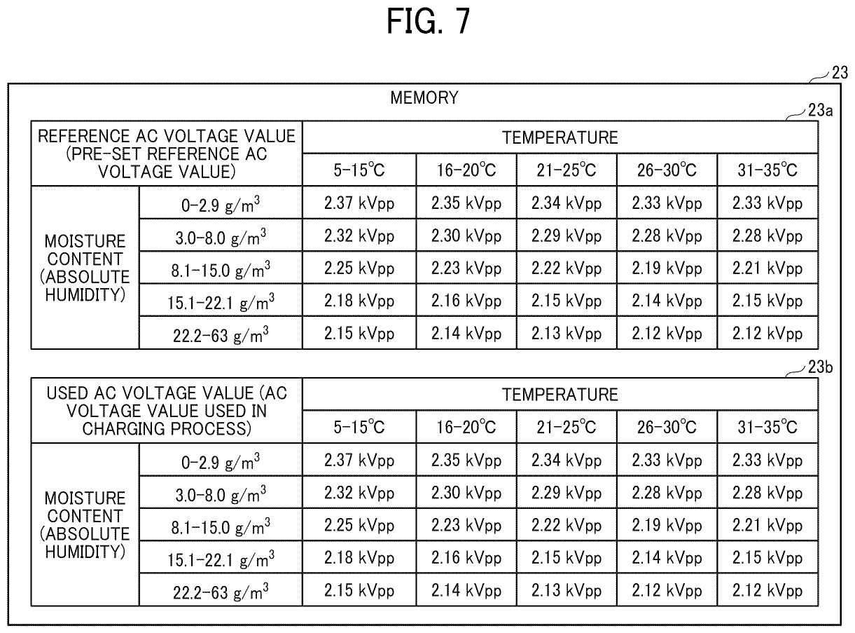

FIG. 7 is a diagram illustrating an example of various data stored in a memory 23 of an image forming apparatus 1 according to a third embodiment of the present disclosure. In a storage area 23b of the memory 23, the same AC voltage value as that of a storage area 23a is set as an initial value in an initial state. In other words, in the storage area 23b of the memory 23, the AC voltage value used in the charging process for each section of the operating environment is overwritten as the used AC voltage value every time the reference AC voltage value in the initial state is stored and the charging process is performed. The configuration of the image forming apparatus 1 according to the third embodiment is substantially the same as the configuration of the image forming apparatus 1 illustrated in FIGS. 1 and 2.

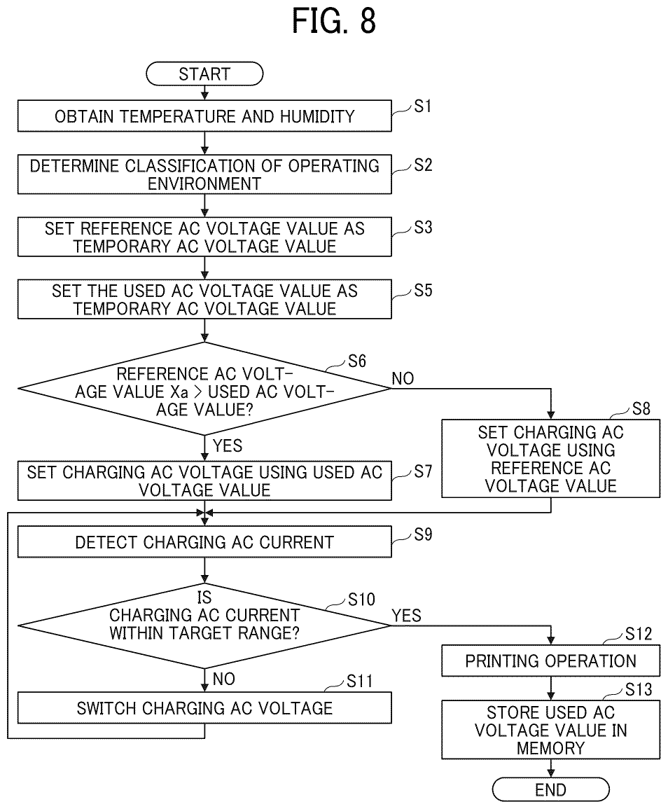

FIG. 8 is a flowchart of an example of the control of the charging current by the controller 20 according to the third embodiment. The same step numbers are assigned to the substantially same processes as those in FIG. 5, and a detailed description thereof may be omitted. FIG. 8 illustrates an example of a control method of the image forming apparatus 1 or an example of a control program of the image forming apparatus 1. In other words, the operation illustrated in FIG. 8 may be implemented by the control program executed by a CPU 201 mounted on the controller 20.

The operation procedure illustrated in FIG. 8 is the same as the operation procedure illustrated in FIG. 5 except that step S5 is performed after step S3. In other words, in the operation procedure of FIG. 8, step S4 is deleted from the operation procedure of FIG. 5.

As illustrated in FIG. 7, the reference AC voltage value is stored in the storage area 23b in the initial state, so that the controller 20 can set the used AC voltage value to the temporary AC voltage value in step S5 every time without determining whether the used AC voltage value is held in the storage area 23b after determining the section of the operating environment in step S2. Since the process of step S4 in FIG. 5 is not performed, the control procedure of the charging current can be simplified accordingly, and the initial setting time of the AC voltage applied to the photoconductor drum 6 can be further shortened.

In the third embodiment, as in the second embodiment in FIG. 6, the memory 23 may have a storage area 23c that stores the replacement history of the components in the printer unit 5. In this case, the storage area 23b is initialized by storing the reference AC voltage value when the components related to the charging process are replaced.

As described above, in the third embodiment, the reference AC voltage value is stored in the initial state of the storage area 23b. Thus, the control procedure of the charging current can be simplified, and the initial setting time of the AC voltage applied to the photoconductor drum 6 can be shortened as in the first embodiment. In the third embodiment, as in the second embodiment, the controller 20 initializes the storage area 23b at the time of replacement of components, which can prevent the AC voltage value used in the charging process before replacement of the components from exerting an influence on the AC voltage value used in the charging process after replacement of the component.

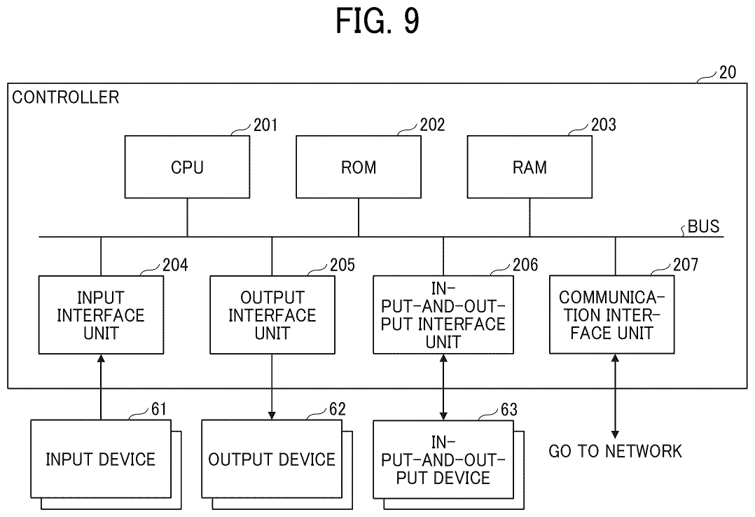

FIG. 9 is a block diagram illustrating an example of a hardware configuration of the controller 20 according to the first to third embodiments. The controller 20 includes the CPU 201, a read-only memory (ROM) 202, and a random-access memory (RAM) 203. The controller 20 includes an input interface unit 204, an output interface unit 205, an input-and-output interface unit 206, and a communication interface unit 207.

For example, the CPU 201, the ROM 202, the RAM 203, the input interface unit 204, the output interface unit 205, the input-and-output interface unit 206, and the communication interface unit 207 are connected to each other via a bus BUS.

The CPU 201 executes various programs such as an operating system (OS) and applications. The ROM 202 holds, for example, a basic program and various parameters for enabling the CPU 201 to execute various programs. The RAM 203 stores, for example, the various programs executed by the CPU 201 and data used in the programs. For example, the various programs may include an image processing program that performs image processing on a document image read by the image reading device 3 and a power supply control program that controls the power supply 30.

For example, an input device 61 such as an input unit mounted to the operation unit 60 of the image reading apparatus 3 and the image forming apparatus 1 is connected to the input interface unit 204. An output device 62 such as the display mounted to the operation unit 60 is connected to the output interface unit 205. An input-and-output device 63 such as an auxiliary storage device and a recording medium is connected to the input-and-output interface unit 206. The communication interface unit 207 can connect the image forming apparatus 1 to, for example, a network.

In a case where various programs such as the image processing program or the power supply control program are stored in a recording medium, the programs may be transferred from the recording medium to, for example, the RAM 203 via the input-and-output interface unit 206 to which the recording medium is connected.

Aspects of the present disclosure are, for example, as follows.

### First Aspect

An image forming apparatus (e.g., the image forming apparatus 1) includes an image bearer (e.g., the photoconductor drum 6), a charger (e.g., the charging roller 11), a voltage generator (e.g., the charging AC voltage generator 41), a current detector (e.g., the charging current feedback unit 42), a measurement unit (e.g., the temperature-and-humidity sensor 25), a first storage (e.g., the storage area 23a), a second storage (e.g., the storage area 23b), and a controller (e.g., the controller 20). An electrostatic latent image is formed on the image bearer. The charger charges the image bearer based on an AC voltage. The voltage generator generates the AC voltage to be supplied to the charger. The current detector detects a current flowing between the voltage generator and the image bearer. The measurement unit measures, as an operating environment, temperature and humidity inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. When the controller detects that the used AC voltage value is stored in a section of a measured operating environment, which is an operating environment measured by the measurement unit, in the second storage, the controller controls the voltage generator to generate an AC voltage based on the used AC voltage value detected. When the used AC voltage value is not stored in the section of the measured operating environment in the second storage, the controller controls the voltage generator to generate an AC voltage based on the reference AC voltage value stored in the section of the measured operating environment in the first storage.

### Second Aspect

In the image forming apparatus (e.g., the image forming apparatus 1) according to the first aspect, when the used AC voltage value stored in the section of the measured operating environment in the second storage (e.g., the storage area 23b) is smaller than an upper limit

AC voltage value obtained by adding a margin to the reference AC voltage value stored in the section of the measured operating environment in the first storage (e.g., the storage area 23a), the controller (e.g., the controller 20) causes the voltage generator (e.g., the charging AC voltage generator 41) to generate an AC voltage based on the used AC voltage value. When the used AC voltage value is the upper limit AC voltage value or more, the controller causes the voltage generator to generate an AC voltage based on the reference AC voltage value.

### Third Aspect

In the image forming apparatus (e.g., the image forming apparatus 1) according to the first or second aspect, the controller (e.g., the controller 20) stores the AC voltage value used for causing the voltage generator (e.g., the charging AC voltage generator 41) to generate an AC voltage, as the used AC voltage value, in the section of the measured operating environment in the second storage (e.g., the storage area 23b).

### Fourth Aspect

The image forming apparatus (e.g., the image forming apparatus 1) according to any one of the first to third aspects, further includes a third storage (e.g., the storage area 23c) to store a replacement history of components in the body of the image forming apparatus, when the replacement history of the components related to a charging process is registered in the third storage, the controller (e.g., the controller 20) initializes the second storage (e.g., the storage area 23b).

### Fifth Aspect

The image forming apparatus (e.g., the image forming apparatus 1) according to the fourth aspect, when the replacement history of the components related to the charging process is registered in the third storage (e.g., the storage area 23c), the controller (e.g., the controller 20) stores the reference AC voltage value stored in the first storage (e.g., the storage area 23a), as the used AC voltage value, in the second storage (e.g., the storage area 23b) to initialize the second storage for each of the sections of the operating environment.

### Sixth Aspect

In the image forming apparatus (e.g., the image forming apparatus 1) according to any one of the first to third aspects, the reference AC voltage value stored in each of the sections of the operating environment in the first storage (e.g., the storage area 23a) is stored in advance as the used AC voltage value in corresponding one of the sections of the operating environment in the second storage (e.g., the storage area 23b).

### Seventh Aspect

In the image forming apparatus (e.g., the image forming apparatus 1) according to any one of the first to third aspects, the controller (e.g., the controller 20) repeats control of causing the voltage generator (e.g., the charging AC voltage generator 41) to generate an AC voltage until the reference AC voltage value or the used AC voltage value is within a target range.

### Eighth Aspect

An image forming apparatus (e.g., the image forming apparatus 1) includes an image bearer (e.g., the photoconductor drum 6), a charger (e.g., the charging roller 11), a voltage generator (e.g., the charging AC voltage generator 41), a current detector (e.g., the charging current feedback unit 42), a measurement unit (e.g., the temperature-and-humidity sensor 25), a first storage (e.g., the storage area 23a), a second storage (e.g., the storage area 23b), and a controller (e.g., the controller 20). An electrostatic latent image is formed on the image bearer. The charger charges the image bearer based on an AC voltage. The voltage generator generates the AC voltage to be supplied to the charger. The current detector detects a current flowing between the voltage generator and the image bearer. The measurement unit measures, as an operating environment, temperature and humidity inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. When the used AC voltage value stored in the section of a measured operating environment, which is an operating environment measured by the measurement unit, in the second storage is smaller than an upper limit AC voltage value obtained by adding a margin to the reference AC voltage value stored in the section of the measured operating environment in the first storage, the controller causes the voltage generator to generate an AC voltage based on the used AC voltage value. When the used AC voltage value is the upper limit AC voltage value or more, the controller causes the voltage generator to generate an AC voltage based on the reference AC voltage value.

### Ninth Aspect

In the image forming apparatus (e.g., the image forming apparatus 1) according to the eighth aspect, the controller (e.g., the controller 20) stores the AC voltage value used for causing the voltage generator (e.g., the charging AC voltage generator 41) to generate an AC voltage, as the used AC voltage value, in the section of the measured operating environment in the second storage (e.g., the storage area 23b).

### Tenth Aspect

The image forming apparatus (e.g., the image forming apparatus 1) according to the eighth or ninth aspect, further includes a third storage (e.g., the storage area 23c) to store a replacement history of components in the body of the image forming apparatus, when the replacement history of the components related to a charging process is registered in the third storage, the controller (e.g., the controller 20) initializes the second storage (e.g., the storage area 23b).

### Eleventh Aspect

In the image forming apparatus (e.g., the image forming apparatus 1) according to the tenth aspect, when the replacement history of the components related to the charging process is registered in the third storage (e.g., the storage area 23c), the controller (e.g., the controller 20) stores the reference AC voltage value stored in the first storage (e.g., the storage area 23a), as the used AC voltage value, in the second storage (e.g., the storage area 23b) to initialize the second storage for each of the sections of the operating environment.

### Twelfth Aspect

In the image forming apparatus (e.g., the image forming apparatus 1) according to any one of the eighth to eleventh aspect, the reference AC voltage value stored in each of the sections of the operating environment in the first storage (e.g., the storage area 23a) is stored in advance as the used AC voltage value in corresponding one of the sections of the operating environment in the second storage (e.g., the storage area 23b).

### Thirteenth Aspect

In the image forming apparatus (e.g., the image forming apparatus 1) according to any one of the eighth to twelfth aspects, the controller (e.g., the controller 20) repeats control of causing the voltage generator (e.g., the charging AC voltage generator 41) to generate an

AC voltage until the reference AC voltage value or the used AC voltage value is within a target range.

### Fourteenth Aspect

A control method is for an image forming apparatus (e.g., the image forming apparatus 1) that includes an image bearer (e.g., the photoconductor drum 6), a charger (e.g., the charging roller 11), a voltage generator (e.g., the charging AC voltage generator 41), a current detector (e.g., the charging current feedback unit 42), a measurement unit (e.g., the temperature-and-humidity sensor 25), s first storage (e.g., the storage area 23a), a second storage (e.g., the storage area 23b), and a controller (e.g., the controller 20). An electrostatic latent image is formed on the image bearer. The charger charges the image bearer based on an AC voltage. The voltage generator generates an AC voltage to be supplied to the charger. The current detector detects a current flowing between the voltage generator and the image bearer. The measurement unit measures, as an operating environment, temperature and humidity inside a body of the image forming apparatus in which the image bearer and the charger are disposed. The first storage stores a reference AC voltage value, which is a reference value of the AC voltage, for each of sections of the operating environment. The second storage stores a used AC voltage value, which is an AC voltage value used to apply the AC voltage to the charger, for each of the sections of the operating environment. When the used AC voltage value stored in the section of a measured operating environment, which is an operating environment measured by the measurement unit, in the second storage is smaller than an upper limit AC voltage value obtained by adding a margin to the reference AC voltage value stored in the section of the measured operating environment in the first storage, the controller causes the voltage generator to generate an AC voltage based on the used AC voltage value. When the used AC voltage value is the upper limit AC voltage value or more, the controller causes the voltage generator to generate an AC voltage based on the reference AC voltage value.

### Fifteenth Aspect

A computer-readable storage medium storing program code for causing the image forming apparatus (e.g., the image forming apparatus 1) to execute the control method according to the fourteenth aspect.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
an image bearer on which an electrostatic latent image is formed;
a charger to charge the image bearer based on an alternating current (AC) voltage;
a voltage generator to generate the AC voltage to be supplied to the charger;
a current detector to detect a current flowing between the voltage generator and the image bearer;
a sensor to measure temperature and humidity, as an operating environment, inside a body of the image forming apparatus in which the image bearer and the charger are disposed;
a first storage to store a reference AC voltage value, which is a reference value of the AC voltage, for each of sections of the operating environment;
a second storage to store a used AC voltage value, which is an AC voltage value used to apply the AC voltage to the charger, for each of the sections of the operating environment; and
circuitry configured to:
control the voltage generator to generate an AC voltage based on the used AC voltage value detected when the circuitry detects that the used AC voltage value is stored in a section of a measured operating environment, which is an operating environment measured by the sensor, in the second storage; and
control the voltage generator to generate an AC voltage based on the reference AC voltage value stored in the section of the measured operating environment in the first storage when the used AC voltage value is absent in the section of the measured operating environment in the second storage.

2. The image forming apparatus according to claim 1, wherein, when the used AC voltage value stored in the section of the measured operating environment in the second storage is smaller than an upper limit AC voltage value obtained by adding a margin to the reference AC voltage value stored in the section of the measured operating environment in the first storage, the circuitry causes the voltage generator to generate an AC voltage based on the used AC voltage value, and
wherein, when the used AC voltage value is the upper limit AC voltage value or more, the circuitry causes the voltage generator to generate an AC voltage based on the reference AC voltage value.

3. The image forming apparatus according to claim 1,
wherein the circuitry stores the AC voltage value used for causing the voltage generator to generate an AC voltage, as the used AC voltage value, in the section of the measured operating environment in the second storage.

4. The image forming apparatus according to claim 1, further comprising a third storage to store a replacement history of components in the body of the image forming apparatus,
wherein the circuitry initializes the second storage when the replacement history of the components related to a charging process is registered in the third storage.

5. The image forming apparatus according to claim 4,
wherein, when the replacement history of the components related to the charging process is registered in the third storage, the circuitry stores the reference AC voltage value stored in the first storage, as the used AC voltage value, in the second storage to initialize the second storage for each of the sections of the operating environment.

6. The image forming apparatus according to claim 1,
wherein the reference AC voltage value stored in each of the sections of the operating environment in the first storage is stored in advance as the used AC voltage value in corresponding one of the sections of the operating environment in the second storage.

7. The image forming apparatus according to claim 1,
wherein the circuitry repeats control of causing the voltage generator to generate an AC voltage, until the reference AC voltage value or the used AC voltage value is within a target range.

8. An image forming apparatus comprising:
an image bearer on which an electrostatic latent image is formed;
a charger to charge the image bearer based on an AC voltage;
a voltage generator to generate the AC voltage to be supplied to the charger;
a current detector to detect a current flowing between the voltage generator and the image bearer;
a sensor to measure, as an operating environment, temperature and humidity inside a body of the image forming apparatus in which the image bearer and the charger are disposed;
a first storage to store a reference AC voltage value, which is a reference value of the AC voltage, for each of sections of the operating environment;
a second storage to store a used AC voltage value, which is an AC voltage value used to apply the AC voltage to the charger, for each of the sections of the operating environment; and
circuitry configured to:
control the voltage generator to generate an AC voltage based on the used AC voltage value when the used AC voltage value stored in a section of a measured operating environment, which is an operating environment measured by the sensor, in the second storage is smaller than an upper limit AC voltage value obtained by adding a margin to the reference AC voltage value stored in the section of the measured operating environment in the first storage; and
control the voltage generator to generate an AC voltage based on the reference AC voltage value when the used AC voltage value is the upper limit AC voltage value or more.

9. The image forming apparatus according to claim 8,
wherein the circuitry stores the AC voltage value used for causing the voltage generator to generate an AC voltage, as the used AC voltage value, in the section of the measured operating environment in the second storage.

10. The image forming apparatus according to claim 8, further comprising a third storage to store a replacement history of components in the body of the image forming apparatus,
wherein, when the replacement history of the components related to a charging process is registered in the third storage, the circuitry initializes the second storage.

11. The image forming apparatus according to claim 10,
wherein, when the replacement history of the components related to the charging process is registered in the third storage, the circuitry stores the reference AC voltage value stored in the first storage, as the used AC voltage value, in the second storage to initialize the second storage for each of the sections of the operating environment.

12. The image forming apparatus according to claim 8,
wherein the reference AC voltage value stored in each of the sections of the operating environment in the first storage is stored in advance as the used AC voltage value in corresponding one of the sections of the operating environment in the second storage.

13. The image forming apparatus according to claim 8,
wherein the circuitry repeats control of causing the voltage generator to generate an AC voltage until the reference AC voltage value or the used AC voltage value is within a target range.

14. A method for controlling an image forming apparatus that includes an image bearer on which an electrostatic latent image is formed, a charger to charge the image bearer based on an AC voltage, a voltage generator to generate the AC voltage to be supplied to the charger, a current detector to detect a current flowing between the voltage generator and the image bearer, a sensor to measure, as operating environment, temperature and humidity inside a body of the image forming apparatus in which the image bearer and the charger are disposed, a first storage to store a reference AC voltage value, which is a reference value of the AC voltage, for each of sections of the operating environment, a second storage to store a used AC voltage value, which is an AC voltage value used to apply the AC voltage to the charger, for each of the sections of the operating environment, and circuitry, the method comprising:
controlling, by the circuitry, the voltage generator to generate an AC voltage based on the used AC voltage value detected when the circuitry detects that the used AC voltage value is stored in a section of a measured operating environment, which is an operating environment measured by the sensor, in the second storage; and
controlling, by the circuitry, the voltage generator to generate an AC voltage based on the reference AC voltage value stored in the section of the measured operating environment of the first storage when the used AC voltage value is absent in the section of the measured operating environment in the second storage.

15. A non-transitory, computer-readable storage medium storing program code for causing the image forming apparatus to execute the method according to claim 14.
